(19) United States
(12) Patent Application Publication
(10) Pub. No.: US 2018/0024762 A1
(43) Pub. Date: Jan. 25, 2018

(54) DATA ACCESS MANAGEMENT IN DISTRIBUTED COMPUTER STORAGE ENVIRONMENTS

(71) Applicant: International Business Machines Corporation, Armonk, NY (US)

(72) Inventors: Scott B. Compton, Hyde Park, NY (US); Trang T. Le, San Jose, CA (US); Carol S. Mellgren, Vail, AZ (US); John R. Paveza, Morgan Hill, CA (US); Dale F. Riedy, Poughkeepsie, NY (US); Harry M. Yudenfriend, Poughkeepsie, NY (US)

(21) Appl. No.: 15/216,740

(22) Filed: Jul. 22, 2016

(51) Int. Cl. G06F 3/06

(52) U.S. Cl. CPC G06F 3/0622; G06F 3/065; G06F 3/067

(57) ABSTRACT

A computer-implemented method includes identifying a computer storage environment comprising a primary storage device and one or more secondary storage devices and determining a secondary data retrieval scenario associated with one of the one or more secondary storage devices. The computer-implemented method further includes determining a read-only retrieval arrangement based on the secondary data retrieval scenario. A corresponding computer program product and computer system are also disclosed.

### BACKGROUND

The present invention relates generally to the field of distributed computer storage environments, and more particularly to data access management in those environments.

In computer storage environments, data access management has important implications for the performance of the system, as well as the consistency of the data across multiple storage systems and host processors. Inefficient methods of data access management in storage computer environments can compromise the speed of data access in those systems. Mismanagement of data access can also lead to inconsistent data patterns across multiple storage systems. Developers and users of computer systems relying on computer storage environments continue to have difficulties with data access management approaches adopted in such environments.

### SUMMARY

A computer-implemented method includes identifying a computer storage environment comprising a primary storage device and one or more secondary storage devices and determining a secondary data retrieval scenario associated with one of the one or more secondary storage devices. The computer-implemented method further includes determining a read-only retrieval arrangement based on the secondary data retrieval scenario. A corresponding computer program product and computer system are also disclosed.

### BRIEF DESCRIPTION OF THE DRAWINGS

FIG. 1 is a block diagram of one embodiment of a computer system environment suitable for operation of a data access management program, in accordance with at least one embodiment of the present invention.

FIG. 2 is a data-flow diagram of a data access management program, in accordance with at least one embodiment of the present invention.

FIG. 3 is a flow-chart diagram of a data access management program, in accordance with at least one embodiment of the present invention.

FIG. 4 is a block diagram of a computing apparatus suitable for executing a data access management program, in accordance with at least one embodiment of the present invention.

### DETAILED DESCRIPTION

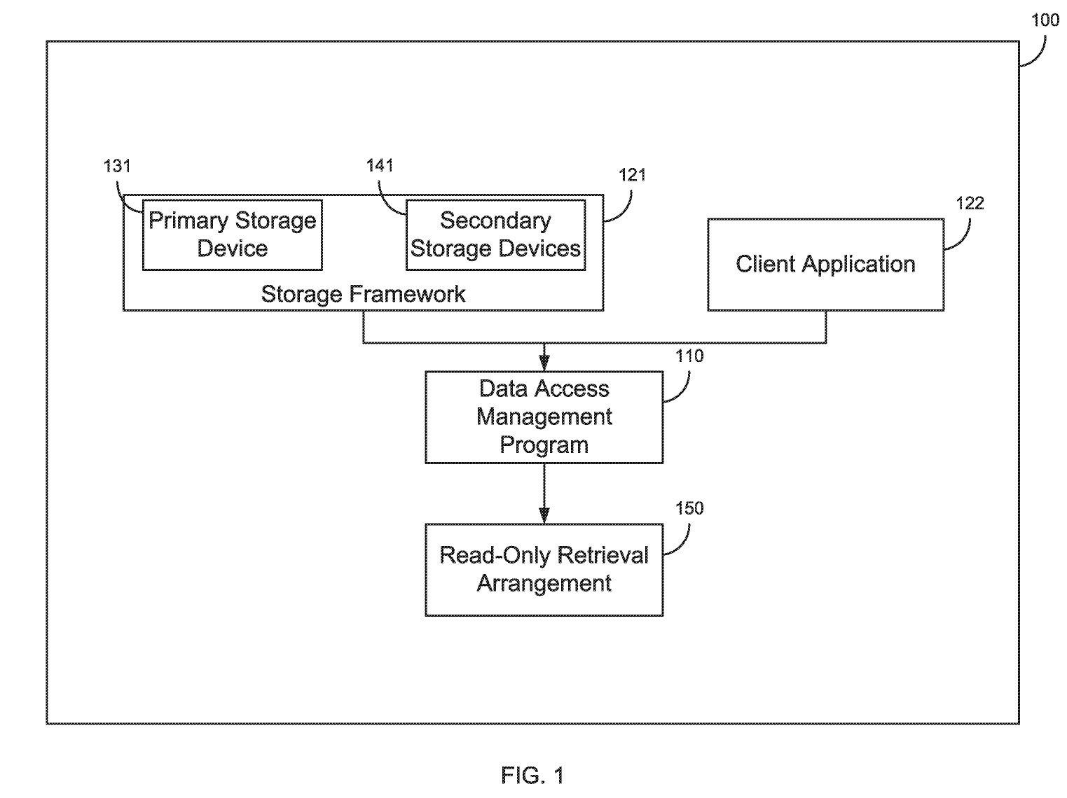

FIG. 1 is a computer system environment 100 suitable for operating a data access management program 110, in accordance with at least one embodiment of the present invention. In the computer system environment 100 depicted in FIG. 1, the program 110 receives at least one information artefact from a storage framework 121 and at least one information artefact from a client application 122. In at least some embodiments, a storage framework is any collection of one or more computer (hardware or software) components that is, at least in part, capable of storing one or more data artefacts (whether in a centralized or distributed manner). In the computer system environment 100 depicted in FIG. 1, the storage framework 121 comprises a primary storage device 131 and one or more secondary storage devices 141. In at least some embodiments, the primary storage device 131 and the one or more secondary storage devices 141 are associated with a disk mirroring arrangement, wherein at least one computer (hardware or software) component ensures that, during regular and non-exceptional executions, the contents of each of the one or more secondary storage devices 141 are synchronously updated to mirror the contents of the primary storage device 131 in at least one time or during at least one time period. In at least some embodiments, the client application 122 is any computer application that, at least one time, initiates and/or requests a process of data access (i.e., retrieval or modification) with respect to at least one data artefact. The primary storage device 131 and the secondary storage devices 132 may reside on the same or different servers.

In the computer system environment 100 depicted in FIG. 1, the data access management program 110 uses the information artefacts received from the storage framework 121 and the client application 122 to determine a read-only retrieval arrangement 150. In at least some embodiments, a read-only retrieval arrangement is any combination of one or more data artefacts that, in whole or in part and directly or when interpreted along with one or more other data artefacts, indicate a plan for data access by the client application 122 to at least one data artefact stored on at least one of the one or more secondary storage devices 141 (i.e., at least one “target secondary data artefact”), wherein the plan ensures and/or guarantees that, during regular and non-exceptional executions, attempts to modify the at least one target secondary data artefact by the client application 122 are halted and/or rejected. In at least some embodiments, the read-only retrieval arrangement prevents all attempted modification of a designated portion of the data artefacts stored on the one or more secondary storage devices 141 (such as all data artefacts stored on the one or more secondary storage devices 141) by the client application 122, and only allows the client application 122 to access the designated portion of data artefacts in a read-only manner.

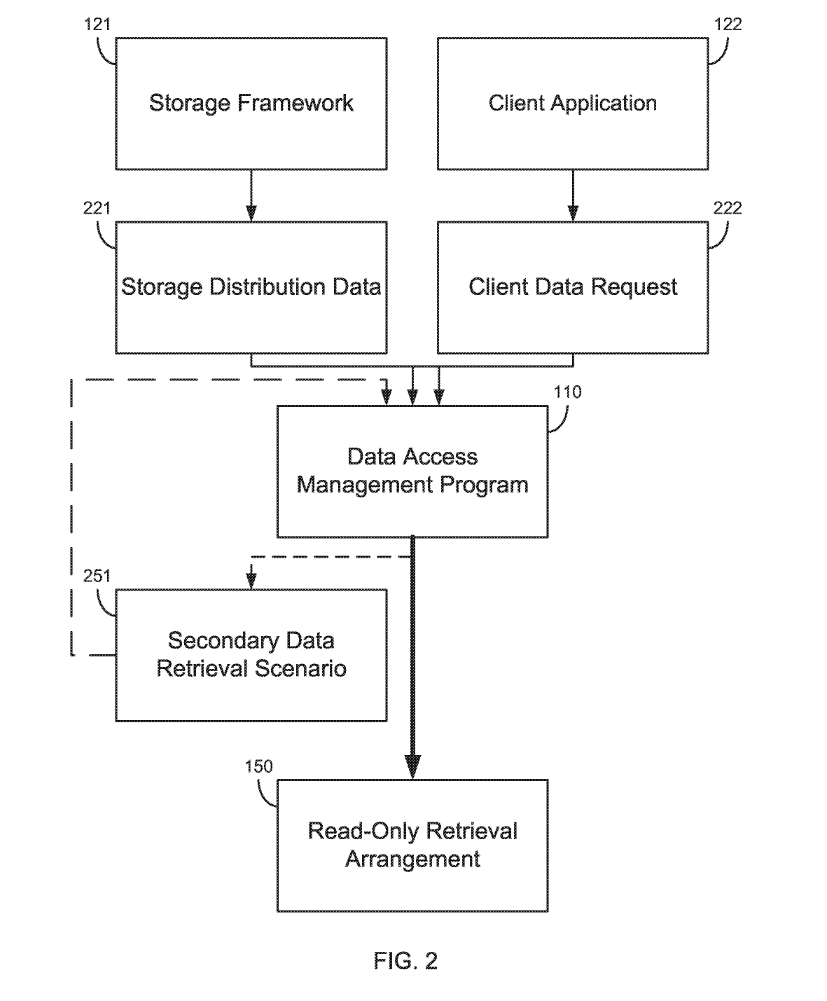

FIG. 2 is a data-flow diagram of a data access management program 110, in accordance with at least one embodiment of the present invention. In the embodiment depicted in FIG. 2, the program receives one or more storage distribution data artefacts 221 from the storage framework 121 and a client data request 222 from the client application 122. In at least some embodiments, a storage distribution data artefact 221 is any data artefact that, in whole or in part and directly or when interpreted with one or more additional data artefacts, indicate at least one information artefact about what data artefacts are stored on one or more components of the storage framework 121 (such as the primary storage device 131 and the one or more secondary storage devices 141). In some embodiments, the one or more storage distribution data artefacts 221 indicate at least one information artefact about a disk mirroring arrangement between the primary storage device 131 and the one or more secondary storage devices 141. In at least some embodiments, a client data request 222 is any combination of one or more data artefacts that, in whole or in part and directly or when interpreted along with one or more additional data artefacts, indicate a request originating from the client application 122 to access at least one data artefact stored on a storage device.

In the embodiment depicted in FIG. 2, the data access management program 110 uses the client data request 222 and the one or more storage distribution data artefacts 221 to determine a secondary data retrieval scenario 251. In at least some embodiments, the secondary data retrieval scenario 251 is any combination of one or more data artefacts that, in whole or in part and directly or when interpreted along with one or more additional data artefacts, indicate a determination about one or more of the following: (i) whether the client application 122 should access at least one data artefact stored on one of the one or more secondary storage devices 122 (i.e., the “target secondary storage device”); and (ii) what specific target secondary storage device and/or one or more target secondary data artefacts should be accessed by the client application 122. In some embodiments, the secondary data retrieval scenario 251 is determined based on one or more secondary data access guidelines, wherein a secondary data access guideline describes a situation when the client application 122 should access at least one data artefact stored on at least one of the one or more secondary storage devices 122. In the embodiment depicted in FIG. 2, the program 110 uses the secondary data retrieval scenario 251 to determine the read-only data retrieval arrangement 150. In some embodiments, the program 110 determines the read-only data retrieval arrangement 150 responsive to the identity and/or one or more features of the target secondary storage device identified in the secondary data retrieval scenario 251.

In some embodiments, the present invention involves a recognition and/or performance of at least one of the following events: (i) an operating system detects that one or more devices are configured in a read-only configuration (or arrangement); (ii) application requests to gain access to devices through some allocation or mount type request; (iii) application attempts to read data from a device that is configured in a read only mode with explicit intent to read from a synchronously mirrored secondary devices; (iv) if the operating system determines that such a requested read is permitted, the operating system indicates in the I/O command that allowing reads from this read-only-configured-device is permitted and delivers the I/O to the target device; and the control unit allows data access (understanding that the device accessed is a synchronously mirrored secondary device and normally not accessible for reads or writes, and understanding that it is the explicit intent of the operating system to allow this read by recognizing the indicator in the command); (v) if the operating system determines that the requested read is not permitted, the operating system does not indicate that the read is allowed and delivers the I/O to the target device (and/or indicates that the read is disallowed to the application and/or control unit); and the control unit rejects the read operation because explicit intent of a synchronously mirrored secondary device is not indicated.

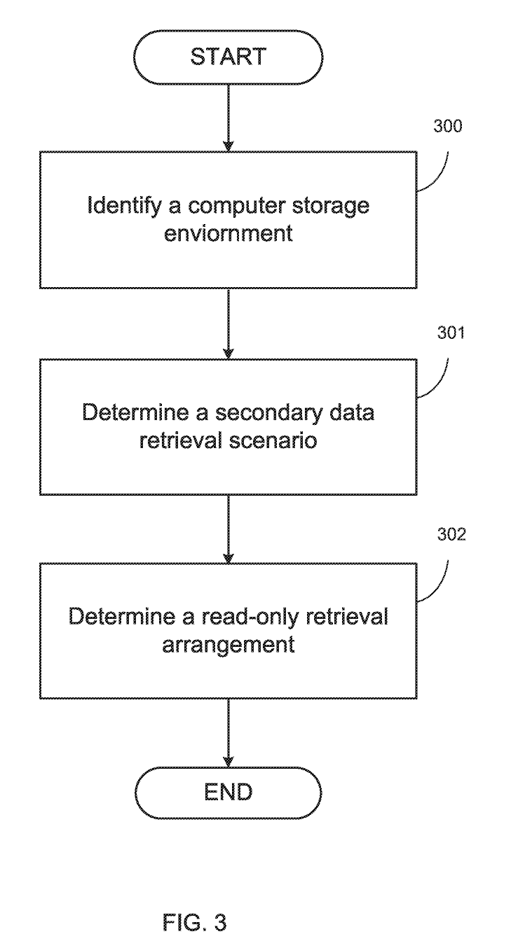

FIG. 3 is a flow-chart diagram of a data access management program, in accordance with at least one embodiment of the present invention. At step 300, the program identifies a computer storage environment comprising a primary storage device and one or more secondary storage devices. At step 301, the program determines a secondary data retrieval scenario associated with one of the one or more secondary storage devices (i.e., the “target secondary storage device”). At step 302, the program determines a read-only retrieval arrangement based on the secondary data retrieval data scenario (e.g., based on identity and/or one or more features of the target secondary storage device identified in the secondary data retrieval scenario).

In some embodiments, determining the secondary storage retrieval scenario comprises determining that at least one secondary data retrieval condition (i.e., a condition that needs to be satisfied before a read-only retrieval arrangement is permitted) is satisfied, wherein the at least one secondary storage retrieval condition is selected from the group consisting of: (i) a computer system component (e.g., an operating system software on a mainframe host) indicating that a read from at least one of the one or more secondary storage devices is permitted (e.g., by setting a corresponding flag in the prefix command of a channel command word); (ii) a computer application (e.g., a recognized data reader application) indicating that it is intending to read from at least one of the one or more secondary storage devices (e.g., one or more synchronously mirrored secondary devices); and (iii) a computer application (e.g., a recognized data reader application) indicating that it is intending to read data in a read-only mode.

In some embodiments, the data access management program further comprises identifying a disk mirroring arrangement with the primary storage device and each of the one or more secondary storage devices. In at least some of those embodiments, the computer storage environment is configured to enforce (i.e., ensure and/or guarantee) the disk mirroring arrangement. In some embodiments, determining the secondary data retrieval scenario further comprises identifying one or more secondary data artefacts stored on each of said one or more secondary storage devices and receiving a user request to retrieve at least one of the one or more secondary data artefacts from at least one of the one or more secondary storage devices. In some embodiments, the program determines that at least one client application should access at least one of the one or more secondary storage devices when at least one target secondary storage device receives a user request to retrieve at least one of the one or more data artefacts stored on the at least one target secondary storage device.

In some embodiments, determining the secondary data retrieval scenario further comprises identifying a data retrieval request, identifying one or more target data artefacts associated with the data retrieval request and being stored on at least one of the one or more secondary storage devices, and determining whether at least one of the one or more target data artefacts is associated with a read-only file mask. In some embodiments, a data retrieval request is any combination of one or more data artefacts that, in whole or in part and directly or in combination with one or more other data artefacts, indicate at least one request for retrieval of (i.e., a read operation on) one or more data artefacts (i.e., one or more target data artefacts). In at least some embodiments, the one or more target data artefacts are stored on and/or stored local to at least one of the one or more secondary storage devices. In some embodiments, a read-only file mask associated with the one or more target data artefacts is any combination of one or more data artefacts that, in whole or in part and directly or in combination with one or more other data artefacts, indicate a determination, recommendation, and/or guideline that no modification of the one or more data artefacts should be allowed during at least one time interval.

In some embodiments, at least one of the one or more secondary storage devices is associated with an IBM® z/OS® operating system. In some embodiments, determining the secondary data retrieval scenario further comprises determining access port overflow scenario associated with the primary storage device. In at least some embodiments, an access port overflow scenario associated with a primary storage device is any combination of one or more data artefacts that, in whole or in part and directly or in combination with one or more other data artefacts, indicate a determination and/or estimation that no access port to the primary storage device is available for use at one time. In at least some embodiments, an access port to a storage device is any combination of one or more computer (hardware or software) components that enable accessing the storage device and/or one or more data artefacts stored on and/or local to the storage device.

In some embodiments, determining the secondary data retrieval scenario further comprises determining a retrieval improvement scenario associated with a client application and at least one of the one or more secondary storage devices. In at least some embodiments, a client application is any combination of one or more computer (hardware or software) components that communicate a request to access data on at least one storage device (e.g., the primary storage device and/or one or more secondary device). In at least some embodiments, the retrieval improvement scenario associated with the client application and at least one of the one or more secondary storage devices is any is any combination of one or more data artefacts that, in whole or in part and directly or in combination with one or more other data artefacts, indicate a determination and/or estimation that at least one property (e.g., speed, integrity, formatting, failure rate) associated with retrieval of at least one data artefact by the client application can be improved if the client application retrieves data from at least one of the one or more secondary storage devices. In some embodiments, determining the secondary data retrieval scenario further comprises determining that the client application's access request with respect to the one or more data artefacts stored on at least one of the one or more secondary storage devices consists of retrieval requests only, and does not consist of any modification requests.

In some embodiments, determining the secondary read-only retrieval arrangement further comprises identifying a secondary data modification (write) request associated with at least one of the one or more secondary storage devices and determining a rejection response associated with the secondary data modification request. In at least some embodiments, a secondary data modification request associated with at least one of the one or more secondary storage devices is any combination of one or more data artefacts that, in whole or in part and directly or in combination with one or more other data artefacts, indicate at least one request for modification of (i.e., a write operation on) at least one data artefact stored on the at least one of the one or more secondary storage devices. In at least some embodiments, a rejection response associated with the secondary data modification request is any combination of one or more data artefacts that, in whole or in part and directly or in combination with one or more other data artefacts, indicate the rejection, halt, and/or prevention of the secondary data modification request.

In some embodiments, determining the read-only retrieval arrangement further comprises communicating a read-only enforcement notification to a storage management component. In some of those embodiments, the storage management component is selected from the group consisting of: (i) a file management system; (ii) an operating system; (iii) a storage controller; and (iv) a hypervisor.

In at least some embodiments, the read-only enforcement notification communicated to a storage management component is any combination of one or more data artefacts that, in whole or in part and directly or in combination with one or more other data artefacts, indicate that at least one data artefact whose storage is managed by the storage management component must be accessed in a read-only arrangement (e.g., all modification requests should be rejected). In at least some embodiments, a storage management component is any combination of one or more computer (hardware or software) components that determines, controls, and/or recommends guidelines for storage, retrieval, and/or modification of at least one data artefact. In at least some embodiments, a file management system is any combination of one or more computer (hardware or software) components that determines, controls, and/or recommends guidelines for management of at least one data file. In at least some embodiments, an operating system is any combination of one or more computer (hardware or software) components that manages computer hardware and software resources and provides common services (e.g., user interface) to computer programs and/or applications. In at least some embodiments, a storage controller is any combination of one or more computer (hardware or software) components that determines, controls, and/or recommends guidelines for management of at least one storage system. In at least some embodiments, a hypervisor is any combination of one or more computer (hardware or software) components that determines, controls, and/or recommends guidelines for creation, administration, operation, and/or management of at least one virtual machine.

Embodiments of the present invention comprise a file system comprising at least one logical data volume, wherein the file system is associated with a read-only guarantee. In some embodiments, the at least one logical data volume is associated with a read-only mask and the read-only guarantee is enforced in response to each read-only mask. In some embodiments, the file system is associated with an IBM® z/OS® operating system.

In at least some embodiments, a file system is a combination of one or more computer software components that control how one or more data artefacts (i.e., the at least one logical data volume) is stored, retrieved, and/or modified on at least one computer storage system. In some embodiments, a read-only file mask associated with the at least one logical data volume is any combination of one or more data artefacts that, in whole or in part and directly or in combination with one or more other data artefacts, indicate a determination, recommendation, and/or guideline that no modification of the at least one logical data volume should be allowed during at least one time interval. In some embodiments, the read-only guarantee associated with the file system is any combination of one or more data artefacts that, in whole or in part and directly or in combination with one or more other data artefacts, indicate a determination, recommendation, and/or guideline that the filesystem should not allow any modification of the at least one logical data volume.

In some embodiments, the present invention comprises a computer-implemented method comprising: (i) identifying one or more secondary storage devices; (ii) determining that at least one secondary data retrieval condition is satisfied, wherein the at least one secondary storage retrieval condition is selected from the group consisting of: (a) a computer system component indicating that a read from at least one of the one or more secondary storage devices is permitted; (b) a computer application indicating that it is intending to read from at least one of the one or more secondary storage devices; and (c) the computer application indicating that it is intending to read data in a read-only mode; and (iii) responsive to determining that at least one secondary data retrieval condition is satisfied, permitting data access from at least one of the one or more secondary storage devices.

Embodiments of the present invention enable data access management in distributed data computer storage environments in a manner that allows for mirroring of one or more storage devices within such environments without the overheads associated with the possibility of modifications to all of those one or more secondary storage devices. The inventors have recognized that by using a read-only data retrieval arrangement with regard to one or more secondary storage devices, the consistency of the data across multiple storage devices within a distributed computer storage environment can be preserved without performance penalties incurred in ensuring that modifications to secondary storage devices are properly reflected across the one or more storage systems within the distributed computer storage environment. Nevertheless, the aforementioned advantages are not required to be present in all of the embodiments of the invention and may not be present in all of the embodiments of the invention.

In general, one or more steps associated with different embodiments of the data access management program may be performed based on one or more pieces of information obtained directly or indirectly from one or more computer (hardware or software) components, one or more pieces of information obtained directly or indirectly from one or more inputs from one or more users, and/or one or more observed behaviors associated with one or more (hardware or software) components of one or more computer system environments. In general, one or more steps of different embodiments of the data access management program may comprise communicating with one or more computer (hardware or software) components, issuing one or more computer instructions (e.g., one or more special purpose machine-level instructions defined in the instruction set of one or more computer hardware components), and/or communicating with one or more computer components at the hardware level. In some embodiments, at least one of the one or more secondary storage devices is associated with a z/OS operating system.

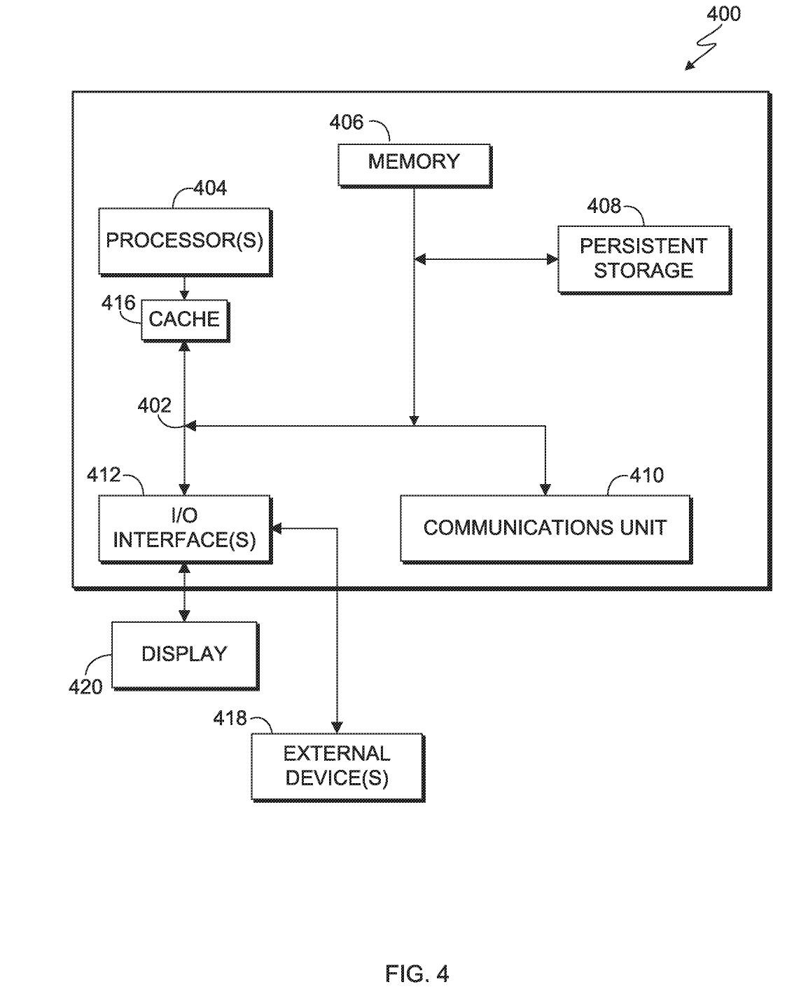

FIG. 4 is a block diagram depicting components of a computer 400 suitable for executing the data access management program. FIG. 4 displays the computer 400, the one or more processor(s) 404 (including one or more computer processors), the communications fabric 402, the memory 406, the RAM, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the data access management program may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The data access management program may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a computer storage environment, said computer storage environment comprising a primary storage device and one or more secondary storage devices;
determining a secondary data retrieval scenario, said secondary data retrieval scenario being associated with one of said one or more secondary storage devices; and
determining a read-only retrieval arrangement based on said secondary data retrieval scenario.

2. The computer-implemented method of claim 1, further comprising:
identifying a disk mirroring arrangement, said disk mirroring arrangement being associated with said primary storage device and each of said one or more secondary storage devices; and
wherein said computer storage environment is configured to enforce said disk mirroring arrangement.

3. The computer-implemented of claim 1, wherein determining said secondary data retrieval scenario further comprises:
identifying one or more secondary data artefacts, said one or more secondary data artefacts being stored on each of said one or more secondary storage devices; and
receiving a user request to retrieve at least one of said one or more secondary data artefacts from at least one of said one or more secondary storage devices.

4. The computer-implemented method of claim 1, wherein determining said secondary data retrieval scenario further comprises:
identifying a data retrieval request;
identifying one or more target secondary data artefacts, said one or more target secondary data artefacts being associated with said data retrieval request and being stored on at least one of said one or more secondary storage devices; and
determining whether at least one of said one or more target data artefacts is associated with a read-only file mask.

5. The computer-implemented method of claim 1, wherein determining said read-only retrieval arrangement further comprises:
identifying a secondary data modification request, said secondary data modification request being associated with at least one of said one or more secondary storage devices; and
determining a rejection response, said rejection response associated with said secondary data modification request.

6. The computer-implemented method of claim 1, wherein at least one of said one or more secondary storage devices is associated with a z/OS operating system.

7. The computer-implemented method of claim 1, wherein determining said secondary data retrieval scenario further comprises:
determining an access port overflow scenario, said access port overflow scenario being associated with said primary storage device.

8. The computer-implemented method of claim 1, wherein determining said secondary data retrieval scenario further comprises:
determining a retrieval improvement scenario, said retrieval improvement scenario being associated with a client application and at least one of said one or more secondary storage devices.

9. The computer-implemented method of claim 1, wherein determining said read-only retrieval arrangement further comprises:
communicating a read-only enforcement notification to a storage management component.

10. The computer-implemented method of claim 1, wherein determining said secondary storage retrieval scenario further comprises determining that at least one secondary data retrieval condition is satisfied, wherein said at least one secondary storage retrieval condition is selected from the group consisting of:
a computer system component indicating that a read from at least one of said one or more secondary storage devices is permitted;
a computer application indicating that it is intending to read from at least one of said one or more secondary storage devices; and
said computer application indicating that it is intending to read data in a read-only mode.

11. A computer-implemented method comprising:
identifying one or more secondary storage devices;
determining that at least one secondary data retrieval condition is satisfied, wherein said at least one secondary storage retrieval condition is selected from the group consisting of:
a computer system component indicating that a read from at least one of said one or more secondary storage devices is permitted;
a computer application indicating that it is intending to read from at least said one of one or more secondary storage devices; and
said computer application indicating that it is intending to read data in a read-only mode; and
responsive to determining that at least one said secondary data retrieval condition is satisfied, permitting data access from at least one of said one or more secondary storage devices.

12. A computer program product, the computer program product comprising one or more computer readable storage media and program instructions stored on said one or more computer readable storage media, said program instructions comprising instructions to:
identify a computer storage environment, said computer storage environment comprising a primary storage device and one or more secondary storage devices;
determine a secondary data retrieval scenario, said secondary data retrieval scenario being associated with one of said one or more secondary storage devices; and
determine a read-only retrieval arrangement based on said secondary data retrieval scenario.

13. The computer program product of claim 12, wherein:
said program instructions further comprise instructions to identify a disk mirroring arrangement, said disk mirroring arrangement being associated with said primary storage device and each of said one or more secondary storage devices; and
said computer storage environment is configured to enforce said disk mirroring arrangement.

14. The computer program product of claim 12, wherein said instruction to determine said secondary data retrieval scenario further comprise instructions to:
identify one or more secondary data artefacts, said one or more secondary data artefacts being stored on each of said one or more secondary storage devices; and
receive a user request to retrieve at least one of said one or more secondary data artefacts from at least one of said one or more secondary storage devices.

15. The computer program product of claim 12, wherein said instructions to determine said secondary data retrieval scenario further comprise instructions to:
identify a data retrieval request;
identify one or more target secondary data artefacts, said one or more target secondary data artefacts being associated with said data retrieval request and being stored on at least one of said one or more secondary storage devices; and
determine whether at least one of said one or more target data artefacts is associated with a read-only file mask.

16. The computer program product of claim 12, wherein said instructions to determine said read-only retrieval arrangement further comprise instructions to:
identifying a secondary data modification request, said secondary data modification request being associated with at least one of said one or more secondary storage devices; and
determine a rejection response, said rejection response associated with said secondary data modification request.

17. The computer program product of claim 12, wherein said instructions to determine said secondary data retrieval scenario further compromise instructions to:
determining an access port overflow scenario, said access port overflow scenario being associated with said primary storage device.

18. The computer program product of claim 12, wherein said instructions to determine said read-only retrieval arrangement further comprises:
communicate a read-only enforcement notification to a storage management component.

19. The computer program product of claim 12, wherein said instructions to determine said secondary storage retrieval scenario further comprise instructions to determine that at least one secondary data retrieval condition is satisfied, wherein said at least one secondary storage retrieval condition is selected from the group consisting of:
a computer system component indicating that a read from at least one of said one or more secondary storage devices is permitted;
a computer application indicating that it is intending to read from at least one of said one or more secondary storage devices; and
said computer application indicating that it is intending to read data in a read-only mode.

20. The computer program product of claim 12, wherein said program instructions further comprise instructions to:
determine that at least one secondary data retrieval condition is satisfied, wherein said at least one secondary storage retrieval condition is selected from the group consisting of:
a computer system component indicating that a read from at least one of said one or more secondary storage devices is permitted;
a computer application indicating that it is intending to read from at least said one of one or more secondary storage devices; and
said computer application indicating that it is intending to read data in a read-only mode; and
responsive to determining that at least one said secondary data retrieval condition is satisfied, permit data access from at least one of said one or more secondary storage devices.
